(19) United States
(12) Patent Application Publication
(10) Pub. No.: US 2025/0147272 A1
(43) Pub. Date: May 8, 2025

(54) REFLECTION MODULE AND CAMERA MODULE INCLUDING THE SAME

(71) Applicant: Samsung Electro-Mechanics Co., Ltd., Suwon-si (KR)

(72) Inventors: Ik Sun LEE, Suwon-si (KR); Sang Joon KIM, Suwon-si (KR); Jae Hoon SIM, Suwon-si (KR); Yoo Chang KIM, Suwon-si (KR)

(73) Assignee: Samsung Electro-Mechanics Co., Ltd., Suwon-si (KR)

(21) Appl. No.: 18/921,716

(22) Filed: Oct. 21, 2024

(30) Foreign Application Priority Data
Nov. 6, 2023 (KR) 10-2023-0152206
Aug. 22, 2024 (KR) 10-2024-0113046

(51) Int. Cl. G02B 7/182; G02B 13/00; G03B 30/00; H04N 23/50

(52) U.S. Cl. CPC G02B 7/1821; G02B 13/0065; G03B 30/00; H04N 23/50

(57) ABSTRACT

A camera module is provided. The camera module includes a housing; a reflection module disposed in the housing, the reflection module including a rotation holder disposed in the housing, and provided with a reflective member; and a rotation guide disposed between the housing and the rotation holder, wherein the rotation holder includes a plurality of buffer members that protrude toward the rotation guide, and wherein the plurality of buffer members may be provided on at least a surface of the rotation holder that faces the rotation guide to protrude toward the rotation guide.

### CROSS-REFERENCE TO RELATED APPLICATIONS

This application claims the benefit under 35 USC § 119(a) of Korean Patent Application Nos. 10-2023-0152206 filed on Nov. 6, 2023, and 10-2024-0113046 filed on Aug. 22, 2024, in the Korean Intellectual Property Office, the entire disclosures of which are incorporated herein by reference for all purposes.

### BACKGROUND

### 1. Field

The following description relates to a reflection module and camera module including the same.

### 2. Description of Related Art

Camera module are being implemented in portable electronic devices such as, but not limited to, smartphones, tablet personal computers (PCs), and laptops, and the camera module may have an autofocus (AF) operation, a handshake correction operation, a zoom operation, and the like.

In order to implement such operations, the camera module may be provided with an actuator that moves reflective members such as a lens and a prism.

The lens and the reflective member may collide with surrounding injection products while moving in an internal space of the housing based on a driving force of the actuator. Specifically, when the reflective member which has a relatively large load collides with the injection products, there may be a problem that the magnitude of impact force and the collision sound inevitably increase.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a camera module includes a housing; a reflection module disposed in the housing, the reflection module including a rotation holder disposed in the housing and provided with a reflective member; and a rotation guide disposed between the housing and the rotation holder, wherein the rotation holder comprises a plurality of buffer members that protrude toward the rotation guide, and wherein the plurality of buffer members are provided on at least a surface of the rotation holder that faces the rotation guide to protrude toward the rotation guide.

The camera module may include a plurality of ball bearings spaced apart from each other in a first direction between the rotation holder and the rotation guide, and configured to support a rotation of the rotation holder with respect to the rotation guide, wherein the plurality of buffer members may be spaced apart from each other in a second direction, perpendicular to the first direction in which the plurality of ball bearings are spaced apart, and the plurality of ball bearings are interposed between the plurality of buffer members.

Each of the plurality of buffer members may further include a protrusion that protrudes toward the rotation guide, and the protrusion protrudes further from a surface of the plurality of buffer members that faces the rotation guide.

The protrusion may have a shape that is inclined in a direction in which the plurality of buffer members are separated.

The protrusion may be formed so that a distance between the protrusion and the rotation guide increases as the protrusion approaches the plurality of ball bearings and the distance between the protrusion and the rotation guide decreases as the protrusion extends away from the plurality of ball bearings.

In a general aspect, a camera module includes a housing; and a reflection module disposed in the housing, the reflection module including a rotation holder disposed in the housing and provided with a reflective member; and a rotation guide disposed between the housing and the rotation holder, wherein the rotation holder includes a first buffer member disposed on a surface that faces the housing; and a second buffer member disposed on a surface that faces the rotation guide.

A first ball bearing, comprising a plurality of ball members that are spaced apart from each other in a first axis direction, may be disposed between the housing and the rotation guide, a second ball bearing including a plurality of ball members spaced apart from each other in a second axis direction, perpendicular to the first axis direction, may be disposed between the rotation guide and the rotation holder, and the rotation holder and the rotation guide may be rotated about the first axis with respect to the housing, and the rotation holder may be rotated about the second axis with respect to the rotation guide and the housing.

The first buffer member may protrude in the second axis direction, and the second buffer member may protrude in a third axis direction, perpendicular to both the first axis and the second axis.

The first buffer member may further include a first protrusion that protrudes toward the housing on a surface of the first buffer member that faces the housing, and the first buffer member may have a shape that is inclined in predetermined direction.

The first protrusion may be formed so that a distance between the first protrusion and the housing increases as the first protrusion approaches the first ball bearing, and the distance from the first protrusion and the housing decreases as the first protrusion moves away from the first ball bearing.

The second buffer member may further include a second protrusion that protrudes toward the rotation guide on a surface of the second buffer member that faces the rotation guide, and the second buffer member has a shape that is inclined in a predetermined direction.

The second buffer member may include a plurality of second buffer members that are spaced apart from each other in the first axis direction with the second ball bearing interposed therebetween.

The second protrusion may be formed so that a distance between the second protrusion and the rotation guide increases as the second protrusion approaches the second ball bearing, and the distance between the second protrusion and the second ball bearing decreases as the second protrusion extends away from the second ball bearing.

The first buffer member and the second buffer member may be integrally formed with the rotation holder through a support frame.

A camera module may include a reflection module a lens module including a plurality of lenses that refract light passing through the reflection module; and an image sensor module comprising an image sensor configured to convert light passing through the lens module into an electrical signal.

The rotation holder may face the housing in a first direction, different from a second direction in which the rotation holder faces the rotation guide, and the plurality of buffer members are further provided on a surface of the rotation holder that faces the housing to protrude toward the housing.

Other features and aspects will be apparent from the following detailed description, the drawings, and the claims.

### BRIEF DESCRIPTION OF DRAWINGS

FIG. 1 illustrates a perspective view of an example portable electronic device including a camera module, in accordance with one or more embodiments.

FIG. 2 illustrates a perspective view of an example camera module, in accordance with one or more embodiments.

FIG. 3 illustrates an internal perspective view of an example camera module, in accordance with one or more embodiments.

FIG. 4 illustrates an exploded perspective view of an example camera module, in accordance with one or more embodiments.

FIG. 5 illustrates a cross-sectional view taken along line I-I′ of FIG. 1.

FIG. 6 illustrates a cross-sectional view taken along line II-II′ of FIG. 1.

FIG. 7 illustrates a perspective view of a rotation holder, in accordance with one or more embodiments.

FIG. 8 is a view illustrating a plurality of buffer members separated from each other in FIG. 7.

FIG. 9 illustrates an exploded perspective view of a rotation holder and a housing, in accordance with one or more embodiments.

FIG. 10 illustrates a cross-sectional view taken along line III-III′ of FIG. 1.

FIG. 11 illustrates an exploded perspective view of a rotation holder and a rotating plate, in accordance with one or more embodiments.

FIG. 12 illustrates a rear view of the rotation holder, in accordance with one or more embodiments.

FIG. 13 illustrates a plan view of a reflection module, in accordance with one or more embodiments.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a reflection module including a buffer member that alleviates shock and noise that may occur when the reflective member rotates. Additionally, one or more examples may provide a camera module including such a reflection module.

In accordance with one or more examples, impact and noise caused by driving the reflective member may be alleviated.

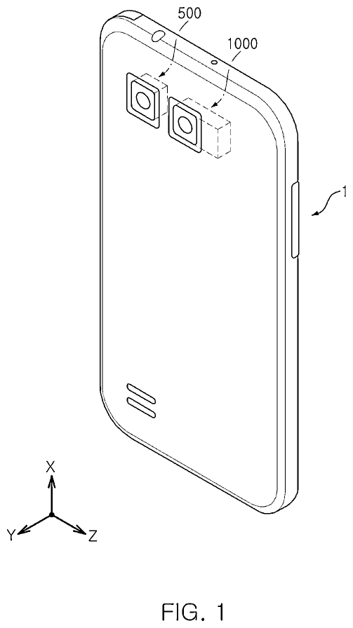

FIG. 1 illustrates a perspective view of an example portable electronic device including a camera module, in accordance with one or more embodiments.

A camera module 1000, in accordance with one or more embodiments, may be mounted on a portable electronic device 1. In an example, the portable electronic device 1 may be a portable electronic device such as, but not limited to, a smartphone, a tablet PC, or the like.

Referring to FIG. 1, a plurality of camera modules 500 and 1000 may be mounted on the portable electronic device 1. The plurality of camera modules 500 and 1000 may be disposed left and right or up and down, as examples. One of the plurality of camera modules 500 and 1000 may be a camera module 1000, in accordance with one or more embodiments, which will be described below.

The camera module 1000, in accordance with one or more embodiments, may include a plurality of lenses, and an optical axis (a Z-axis) of the plurality of lenses may face a direction, perpendicular to a thickness direction of the portable electronic device (Y-axis direction, e.g., a direction from a front surface of the portable electronic device 1 to a rear surface, or an opposite direction thereof).

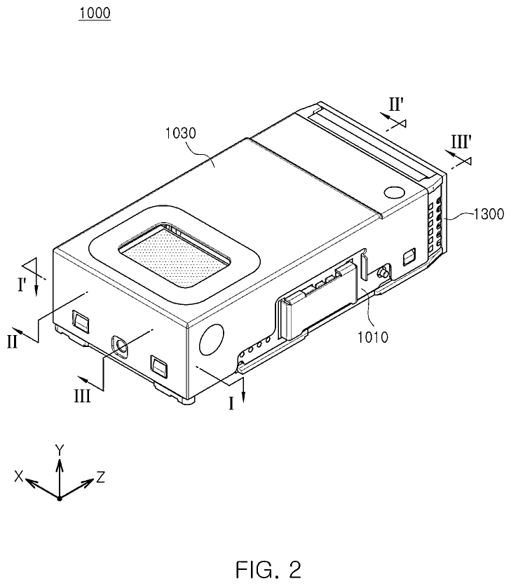

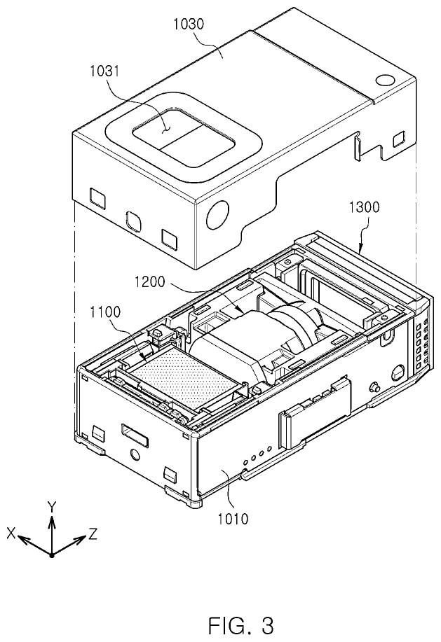

FIG. 2 illustrates a perspective view of an example camera module, in accordance with one or more embodiments, and FIG. 3 illustrates an internal perspective view of a camera module, in accordance with one or more embodiments.

Referring to FIG. 2 and FIG. 3, the camera module 1000, in accordance with one or more embodiments, may include a housing 1010 and a reflection module 1100, a lens module 1200, and an image sensor module 1300 provided in the housing 1010.

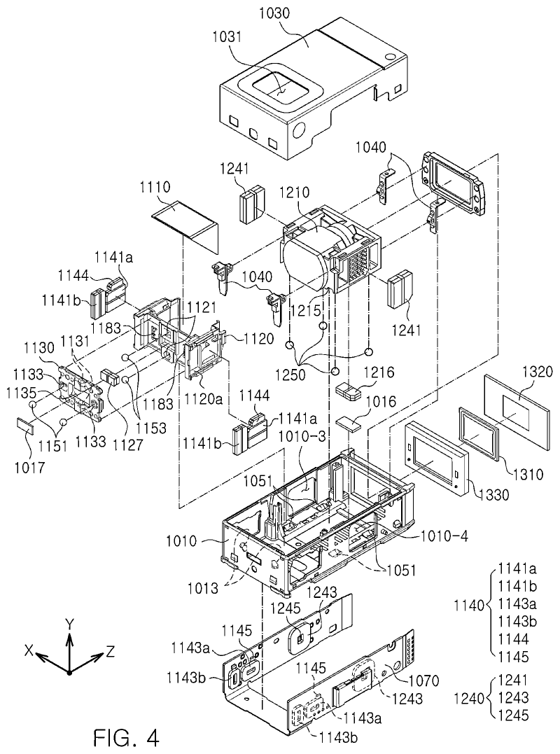

The reflection module 1100 may change a movement direction of light. The reflection module 1100 may include a reflective member 1110 (FIG. 4) that changes a path of light. In an example, the reflective member 1110 may be provided as a prism, a mirror, or like.

A direction of light incident through an opening 1031 of a cover 1030 disposed to cover an upper portion of the housing 1010 may be changed to a direction toward the lens module 1200 by the reflection module 1100.

Light incident in a thickness direction (Y-axis direction) of the camera module 1000 may allow a path thereof to be changed so that the light approximately coincides with an optical axis (Z-axis) in the reflection module 1100, and may be incident on the lens module 1200.

The lens module 1200 may include a plurality of lenses that are disposed in the optical axis direction (Z-axis direction).

Referring to FIG. 4, the image sensor module 1300 may include an image sensor 1310 that is configured to convert light passing through the lens module 1200 into an electric signal, and a printed circuit board 1320 on which the image sensor 1310 is mounted.

Additionally, the image sensor module 1300 may include an optical filter 1330 that filters light incident on the image sensor 1310. In an example, the optical filter 1330 may be an infrared blocking filter.

Referring to FIG. 3 and FIG. 4, a reflection module 1100 may be provided in front of the lens module 1200 in an internal space of the housing 1010, and an image sensor module 1300 may be provided in the rear of the lens module 1200.

Additionally, an outer surface of the housing 1010 may be provided with a first driver 1140 that drives the reflection module 1100, a second driver 1240 that drives the lens module 1200, and respective substrates 1070 and 1320, such as a main substrate 1070 and a sensor substrate 1320, that supply power to the image sensor 1310, or transmits/receives a control signal to/from the image sensor 1310.

FIG. 4 illustrates an exploded perspective view of an example camera module.

A camera module 1000, in accordance with one or more embodiments, may implement an autofocus (AF) operation as a lens module 1200 moves in the optical axis direction (Z-axis direction).

The lens module 1200 may include a lens holder 1210 on which a plurality of lenses are mounted. Referring to FIG. 4, an embodiment in which one lens holder 1210 is provided is illustrated. However, this is only an example, and a plurality of lens holders may be provided. The plurality of lenses may be directly mounted on the lens holder 1210, or may be mounted on the lens holder 1210 via a lens barrel.

The autofocus (AF) operation of the camera module 1000 may be implemented by a movement of the lens holder 1210 provided with the plurality of lenses in the optical axis direction (Z-axis direction). When the plurality of lens holders are provided, the autofocus (AF) operation and a zoom operation may be implemented as one or more lens holders move in the optical axis direction (Z-axis direction). The plurality of lens holders may be provided to be independently movable.

The lens holder 1210 may be moved in the optical axis direction (Z-axis direction) by the second driver 1240.

Referring to FIG. 4, the second driver 1240 may include a plurality of magnets 1241 and a plurality of coils 1243 disposed to face the plurality of magnets 1241. The magnets 1241 and the coils 1243 do not necessarily need to be provided in plural, and one or more magnets and coils may be provided.

Each magnet 1241 may be magnetized to have an N pole and an S pole (or vice versa) in order in an optical axis direction (Z-axis direction), and may correspond one-to-one with the coil 1243.

When power is applied to the plurality of coils 1243, the lens holder 1210 may move in the optical axis direction (Z-axis direction) based on the electromagnetic influence between the plurality of magnets 1241 and the plurality of coils 1243.

In an example embodiment, a plurality of magnets 1241 may be disposed on each of both side surfaces of the lens holder 1210, and a plurality of coils 1243 may be disposed on each of both side surfaces of the housing 1010 so as to face the plurality of magnets 1241, respectively.

Additionally, in an example, the plurality of coils 1243 may be mounted on the main board 1070, and the main board 1070 may be attached to an outer surface of the housing 1010. The housing 1010 may include through-holes 1010-3 and 1010-4 that expose the plurality of coils 1243 into an interior of the housing 1010 so that the plurality of magnets 1241 and the plurality of coils 1243 directly face each other.

The second driver 1240 may include a position detection sensor 1245 sensing a position of the lens holder 1210. In an example, the position detection sensor 1245 may be a Hall sensor.

In an example, the position detection sensor 1245 may be disposed on the inside or outside of the coil 1243, and may be mounted on the main board 1070 along with the coil 1243.

In an example, the lens holder 1210 may move smoothly in the optical axis direction (Z-axis direction) on a bottom surface of the housing 1010 through a plurality of ball members 1250. The plurality of ball members 1250 may be provided in an amount of three or more, as only an example.

In an example, guide grooves 1215 and 1015 extending in the optical axis direction (Z-axis direction) may be provided on the bottom surface of the lens holder 1210 and the housing 1010. The plurality of ball members 1250 may be inserted between the guide grooves 1215 and 1015 so as to guide the movement of the lens holder 1210 while rolling along the guide grooves 1215 and 1015 in the optical axis direction (Z-axis direction).

In order for the plurality of ball members 1250 to continuously contact the guide grooves 1215 and 1015 during the movement of the lens holder 1210, the camera module 1000 may include a pulling device that pulls the lens holder 1210 toward the bottom surface of the housing 1010.

The pulling device may be disposed to face each other on the lens holder 1210 and the housing 1010. For example, the pulling device may be provided with a magnetic member, and a pulling magnet 1216 may be placed in the lens holder 1210, and a pulling yoke 1016 may be disposed in the housing 1010. Positions of the pulling magnet 1216 and the pulling yoke 1016 may be exchanged. The pulling magnet 1216 and the pulling yoke 1016 may generate attractive force in an opposite direction (Y-axis direction).

The movement of the lens holder 1210 in the optical axis direction (Z-axis direction) may be a relative movement with respect to the housing 1010. Accordingly, when the lens holder 1210 moves in the optical axis direction (Z-axis direction), the gap between the lens holder 1210 and the counterpart housing 1010 may become closer.

The camera module 1000 may include a stopper 1040 configured to limit a movement distance of the lens holder 1210 to prevent a collision between the lens holder 1210 and the housing 1010.

The stopper 1040 may be disposed on the housing 1010 so as to face the lens holder 1210 in the optical axis direction (Z-axis direction). The lens holder 1210 may be in contact with the stopper 1040 instead of the housing 1010.

Referring again to FIG. 4, the camera module 1000, in accordance with one or more embodiments, may implement an optical image stabilization (OIS) operation based on the rotation of the reflection module 1100.

When capturing an image or a video, the image may be blurred or the video may shake due to the user's hand shaking, or the like, and the camera module 1000 may compensate for the user's hand shaking or the like, by rotating the reflection module 1100 in a direction that offsets the shaking.

The reflection module 1100 may include a rotation holder 1120 on which the reflective member 1110 is mounted.

The rotation holder 1120 may be rotatably accommodated in the housing 1010. For example, the rotation holder 1120 may be rotated about a first axis (X-axis) and a second axis (Y-axis), perpendicular to the optical axis (Z-axis), while being accommodated in the housing 1010. The optical image stabilization (OIS) operation of the camera module 1000 may be implemented by the rotation of the rotation holder 1120.

The reflection module 1100 may include a rotation guide 1130 disposed between the rotation holder 1120 and the housing 1010.

In an example embodiment, a first ball bearing 1151 may be disposed between the housing 1010 and the rotation guide 1130, and a second ball bearing 1153 may be disposed between the rotation guide 1130 and the rotation holder 1120.

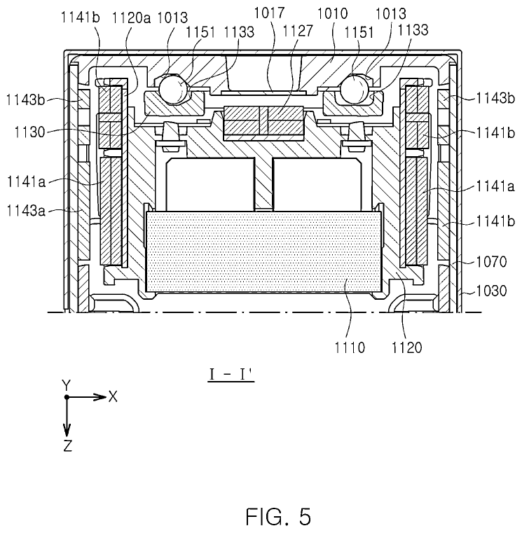

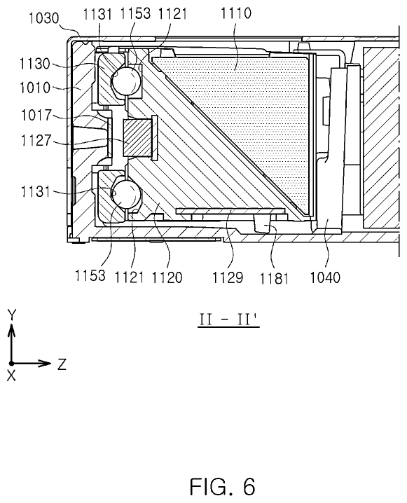

FIG. 5 is a cross-sectional view taken along line I-I′ of FIG. 1, and FIG. 6 is a cross-sectional view taken along line II-II′ of FIG. 1.

Referring to FIG. 5, one surface of the rotation guide 1130 may be spaced apart from an inner side of the housing 1010 with the first ball bearing 1151 interposed therebetween. A first receiving groove 1133 and a second receiving groove 1013 may be provided on surfaces on which the rotation guide 1130 and the housing 1010 face each other. The first ball bearing 1151 may be inserted between the first receiving groove 1133 and the second receiving groove 1013. Some of the first receiving groove 1133 and the second receiving groove 1013 may be provided in a different shape from the others.

The first ball bearing 1151 may maintain a gap between an inner surface of the housing 1010 and the rotation guide 1130. Additionally, the first ball bearing 1151 may be a first axis (X-axis), which is a rotational axis of the rotation holder 1120.

In an example embodiment, the first ball bearing 1151 may include two ball members spaced apart in a first axis direction (X-axis direction), and the first axis (X-axis) may penetrate through the two ball members. The first ball bearing 1151 may operate as a rotational axis while rotating in place while being inserted between the first receiving groove 1133 and the second receiving groove 1013.

Referring to FIG. 6, the other surface of the rotation guide 1130 may be spaced apart from the rotation holder 1120 with the second ball bearing 1153 interposed therebetween. A third receiving groove 1131 and a fourth receiving groove 1121 may be provided on surfaces in which the rotation guide 1130 and the rotation holder 1120 face each other. The second ball bearing 1153 may be inserted between the third receiving groove 1131 and the fourth receiving groove 1121. Some of the third receiving groove 1131 and the fourth receiving groove 1121 may be provided in a different shape from the others.

The second ball bearing 1153 may maintain a gap between the rotation holder 1120 and the rotation guide 1130. Additionally, the second ball bearing 1153 may be a second axis (Y-axis), which is another rotational axis of the rotation holder 1120.

In an example embodiment, the second ball bearing 1153 may include two ball members spaced apart from each other in a second axis direction (Y-axis direction), and the second axis (Y-axis) may penetrate through the two ball members. The second ball bearing 1153 may function as a rotational axis while rotating in place while being inserted between the third receiving groove 1131 and the fourth receiving groove 1121.

In an example embodiment, the rotation holder 1120 and the rotation guide 1130 may be supported on the inner surface of the housing 1010 with the first ball bearing 1151 and the second ball bearing 1153 therebetween, respectively. Accordingly, the camera module 1000 may include a pulling device that pulls the rotation holder 1120 toward the inner surface of the housing 1010.

The pulling device may be disposed to face each other on the rotation holder 1120 and the housing 1010. In an example, the pulling device may be provided as a magnetic member, and a pulling magnet 1127 may be disposed on the rotation holder 1120, and a pulling yoke 1017 may be disposed on the housing 1010. Positions of the pulling magnet 1127 and the pulling yoke 1017 may be exchanged.

The rotation guide 1130 disposed between the rotation holder 1120 and the housing 1010 may include a through-hole 1135, and the pulling magnet 1127 and the pulling yoke 1017 may face each other through the through-hole 1135. The pulling magnet 1127 and the pulling yoke 1017 may generate an attractive force in a direction (Z-axis direction) in which the pulling magnet 1127 and the pulling yoke 1017 oppose each other. Based on the attractive force between the pulling magnet 1127 and the pulling yoke 1017, the first ball bearing 1151 and the second ball bearing 1153 may be continuously in contact with the first to fourth receiving grooves 1133, 1013, 1131 and 1121 in which the first ball bearing 1151 and the second ball bearing 1153 are seated.

The rotation holder 1120, that is provided with the reflective member 1110, may be rotated about the first axis (X-axis) and the second axis (Y-axis) by the first driver 1140. In an example embodiment, when the rotation holder 1120 is rotated about the first axis (X-axis), the rotation guide 1130 may also be rotated together, and the rotation of the rotation holder 1120 about the second axis (Y-axis) may be a relative rotation with respect to the rotation guide 1130. However, when positions of the first ball bearing 1151 and the second ball bearing 1153 are changed, the rotation guide 1130 may be rotated about the second axis (Y-axis) along with the rotation holder 1120, and the rotation of the rotation holder 1120 about the first axis (X-axis) may be a relative rotation with respect to the rotation guide 1130.

Referring to FIG. 4, the first driver 1140 may include a plurality of magnets 1141a and 1141b and a plurality of coils 1143a and 1143b disposed to face the plurality of magnets 1141a and 1141b.

The plurality of magnets 1141a and 1141b may include a first driving magnet 1141a that rotates the rotation holder 1120 about a first axis (X-axis) and a second driving magnet 1141b that rotates the rotation holder 1120 about a second axis (Y-axis).

In an example embodiment, two first driving magnets 1141a and two second driving magnets 1141b may be provided, respectively, and may be divided and mounted on both side surfaces of the rotation holder 1120. That is, the first driving magnet 1141a and the second driving magnet 1141b may be arranged on one side surface of the rotation holder 1120. For example, the first driving magnet 1141a and the second driving magnet 1141b may be disposed to be parallel in the optical axis direction (Z-axis direction). Both side surfaces of the rotation holder 1120 may extend (hereinafter, referred to as an extension portion 1120a) to an opposite side (e.g., -Z-axis direction) of the reflective member 1110. A portion of the second driving magnet 1141b may be disposed in the extension portion 1120a.

The first driving magnet 1141a may be magnetized to have an N pole and an S pole (or vice versa) in order along the first axis direction (X-axis direction), and the second driving magnet 1141b may be magnetized to have an N pole and an S pole (or vice versa) in order along the second axis direction (Y-axis direction).

The plurality of coils 1143a and 1143b may include a first driving coil 1143a disposed to face the first driving magnet 1141a and a second driving coil 1143b disposed to face the second driving magnet 1141b. The first driving coil 1143a and the second driving coil 1143b may correspond one-to-one with the first driving magnet 1141a and the second driving magnet 1141b.

When power is applied to the plurality of coils 1143a and 1143b, the rotation holder 1120 may be rotated about the first axis (X-axis) and/or the second axis (Y-axis) based on an electromagnetic influence force between the plurality of magnets 1141a and 1141b facing the plurality of coils 1143a and 1143b and the plurality of coils 1143a and 1143b.

The plurality of coils 1143a and 1143b may be mounted on the main board 1070, and the main board 1070 may be attached to the outer surface of the housing 1010. The housing 1010 may include through-holes 1010-1 and 1010-2 configured to expose the plurality of coils 1143a and 1143b into the interior of the housing 1010 so that the plurality of magnets 1141a and 1141b and the plurality of coils 1143a and 1143b directly face each other.

The first driver 1140 may include a position sensing device that senses a position of the reflection holder 1120. The position sensing device may include a sensing magnet 1144 and a position detection sensor 1145. In an example, the position detection sensor 1145 may be a Hall sensor.

Two sensing magnets 1144 may be provided and may be mounted on both side surfaces of the rotation holder 1120 together with the first driving magnet 1141a and the second driving magnet 1141b, respectively. The sensing magnet 1144 may be spaced apart from the first driving magnet 1141a in the first axis direction (X-axis direction).

The sensing magnet 1144 may have a polarity that is opposite to a polarity region of the first driving magnet 1141a disposed adjacently to the sensing magnet 1144. For example, the sensing magnet 1144 may be provided to have an N pole or a S pole.

The position detection sensor 1145 may be mounted on the main board 1070 along with the plurality of coils 1143a and 1143b. The position detection sensor 1145 may be disposed on the outside of the plurality of coils 1143a and 1143b, and may be spaced apart from the first driving coil 1143a in the first axial direction (X-axis direction).

The position detection sensor 1145 may face a polarity region of the sensing magnet 1144 and the first driving magnet 1141a disposed adjacently to the sensing magnet 1144.

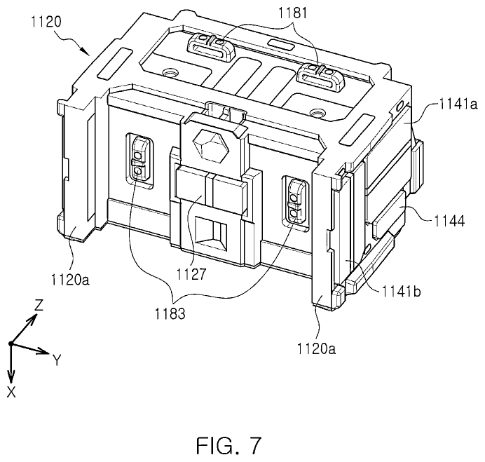

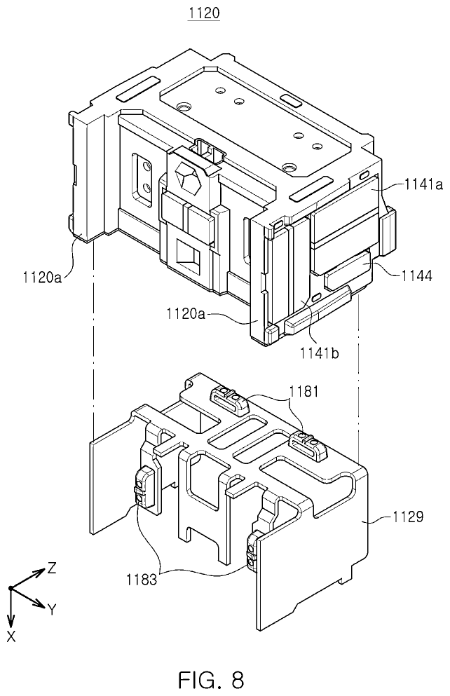

FIG. 7 illustrates a perspective view of a rotation holder, in accordance with one or more embodiments, and FIG. 8 is a view illustrating a plurality of buffer members separated from the rotation holder of FIG. 7.

Referring to FIG. 7, the rotation holder 1120 may be provided with a plurality of buffer members 1181 and 1183. The plurality of buffer members 1181 and 1183 may be provided to protrude from the rotation holder 1120 toward a counterpart. In an example, since the plurality of buffer members 1181 and 1183 directly collide with the counterpart in a state in which the rotation holder 1120 is rotated to the maximum position, a direct collision between the rotation holder 1120 and the counterpart may be prevented. Additionally, since the plurality of buffer members 1181 and 1183 are in contact with the counterpart, a rotation range of the rotation holder 1120 may be limited.

The plurality of buffer members 1181 and 1183 may be formed of a soft material to alleviate shocks or noise caused by the collision. For example, the plurality of buffer members 1181 and 1183 may be formed of a Liquid Crystal Polymer (LCP) material, and may also include a material that absorbs shocks, such as urethane, rubber, silicone, or sponge.

In an example embodiment, the plurality of buffer members 1181 and 1183 may be provided integrally with the rotation holder 1120. For example, the plurality of buffer members 1181 and 1183 may be directly inserted into the rotation holder 1120. That is, a separate manufacturing process for assembling the plurality of buffer members 1181 and 1183 into the rotation holder 1120 may be omitted, and the rotation holder 1120 itself may be provided in a form including the plurality of buffer members 1181 and 1183.

In an example embodiment, the plurality of buffer members 1181 and 1183 may be attached to the rotation holder 1120 through a support frame 1129. For example, the support frame 1129 may be formed of a steel material member inserted into the rotation holder 1120. The plurality of buffer members 1181 and 1183 may be disposed in the rotation holder 1120 in a state of being attached to the support frame 1129.

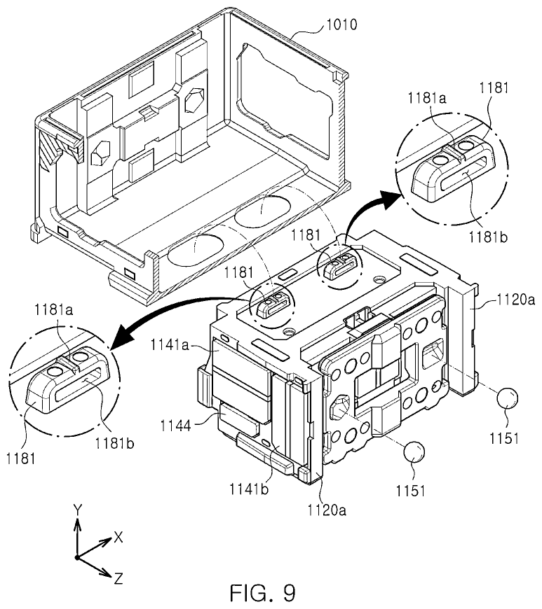

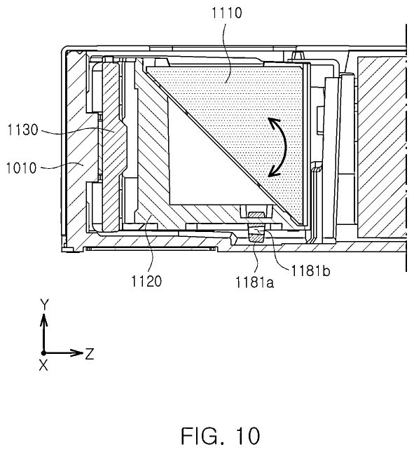

FIG. 9 is an exploded perspective view of a rotation holder and a housing, in accordance with one or more embodiments, and FIG. 10 is a cross-sectional view of III-III′ of FIG. 1.

In an example embodiment, the rotation holder 1120 may include a first buffer member 1181 disposed on a surface facing the bottom surface of the housing 1010 (hereinafter, a bottom surface of the rotation holder 1120).

The first buffer member 1181 may be provided in plural, and a plurality of first buffer members 1181 may be spaced apart from each other in the first axis direction (X-axis direction) on the bottom surface of the rotation holder 1120.

The first buffer member 1181 may be provided to protrude from the bottom surface of the rotation holder 1120 toward the bottom surface of the housing 1010, so that when the rotation holder 1120 is rotated about the first axis (X-axis) with respect to the housing 1010, the collision generated in the second axis direction (Y-axis direction) may be prevented.

The first buffer member 1181 may include a first protrusion 1181a and a first damping hole 1181b.

The first protrusion 1181a may be a portion that protrudes further toward the bottom surface of the housing 1010 than a surrounding region on a surface of the first buffer member 1181 opposing the bottom surface of the housing 1010. Accordingly, in a state in which the rotation holder 1120 is rotated to the maximum position, the first protrusion 1181a of the first buffer member 1181 may first be in contact with the bottom surface of the housing 1010.

In an example embodiment, the first protrusion 1181a may have a shape that is inclined in one direction. The first protrusion 1181a may have a shape that is inclined in a direction (Z-axis direction) in which the first buffer member 1181 is spaced apart from the first axis (X-axis).

In an example, the first protrusion 1181a may be provided in a form in which a distance between the first protrusion 1181a and the bottom surface of the housing 1010 increases as the first protrusion 1181a approaches the first axis (X-axis), and conversely, the distance between the first protrusion 1181a and the bottom surface of the housing 1010 decreases as the first protrusion 1181a moves away from the first axis (X-axis). According to the structure as described above, since a gap between the first buffer member 1181 and the housing 1010 is formed narrowly in a portion in which a rotation amount of the rotation holder 1120 is relatively large, the collision may be effectively prevented.

The first damping hole 1181b may be provided so as to penetrate through the first buffer member 1181. The first damping hole 1181b may be provided between a surface of the first buffer member 1181 facing the housing 1010, e.g., a surface including the first protrusion 1181a, and the bottom surface of the rotation holder 1120, thereby absorbing shocks transmitted from the first protrusion 1181a to the rotation holder 1120. However, the first damping hole 1181b may be omitted.

The first buffer member 1181 may be spaced apart from the bottom surface of the housing 1010 when the rotation holder 1120 is in a neutral position, e.g., in a state in which the bottom surface of the rotation holder 1120 and the bottom surface of the housing 1010 are parallel to each other, and when the rotation holder 1120 rotates about the first axis (X-axis), a gap from the bottom surface of the housing 1010 may decrease, so that the first buffer member 1181 may first be in contact with the bottom surface of the housing 1010.

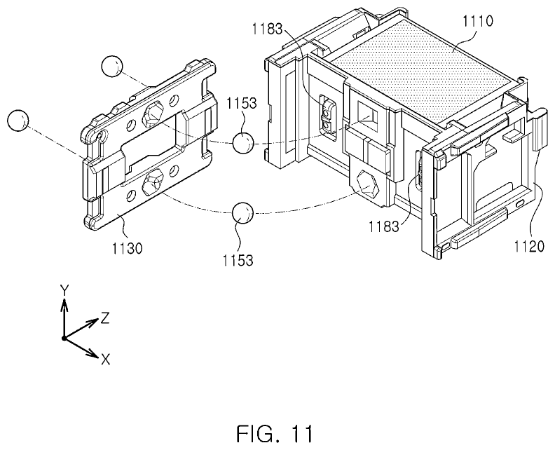

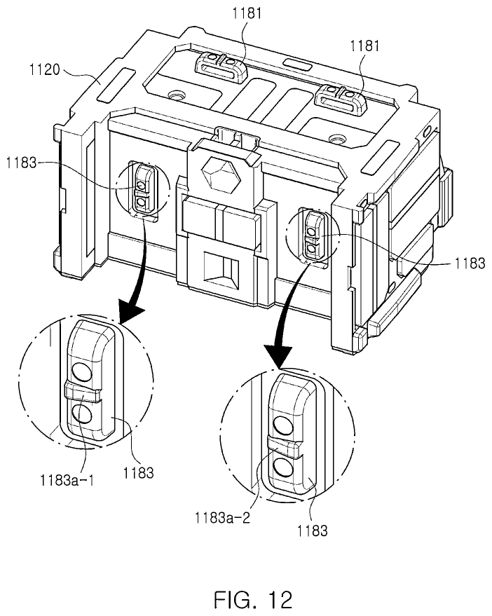

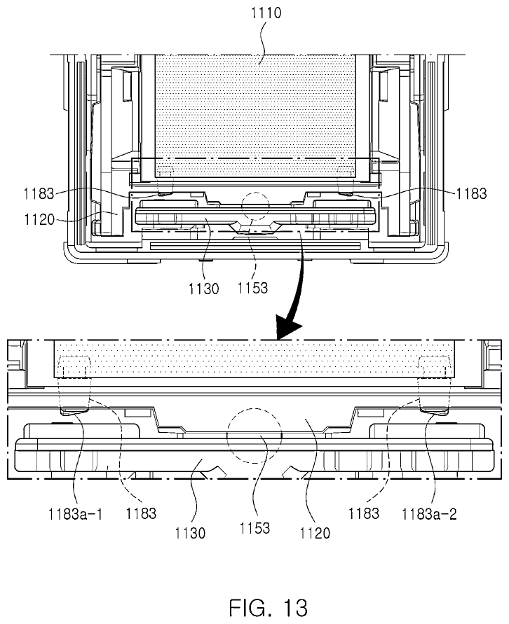

FIG. 11 is an exploded perspective view of a rotation holder and a rotating plate, in accordance with one or more embodiments, FIG. 12 is a rear view of a rotation holder, in accordance with one or more embodiments, and FIG. 13 is a plan view of a reflection module, in accordance with one or more embodiments.

In an example embodiment, the rotation holder 1120 may include a second buffer member 1183 disposed on a surface facing the rotation guide 1130 (hereinafter, one surface of the rotation holder 1120).

The second buffer member 1183 may be provided in plural, and a plurality of second buffer members 1183 may be spaced apart from each other in the first axis direction (X-axis direction) on one surface of the rotation holder 1120. Referring to FIG. 10, the plurality of second buffer members 1183 may be spaced apart from each other in the first axis direction (X-axis direction) with the second axis (Y-axis) interposed therebetween.

The second buffer member 1183 may be provided to protrude toward the rotation guide 1130 on one surface of the rotation holder 1120, and when the rotation holder 1120 is rotated about the second axis (Y-axis) with respect to the rotation guide 1130, the collision generated in an optical axis (or third axis) direction (Z-axis direction) may be prevented.

Referring to FIG. 12, the second buffer member 1183 may include second protrusions 1183a-1 and 1183a-2.

The second protrusions 1183a-1 and 1183a-2 may be portions that protrude further toward the rotation guide 1130 than a surrounding region on a surface of the second buffer member 1183 opposing the rotation guide 1130. Accordingly, when the rotation holder 1120 is rotated to the maximum position, the second protrusions 1183a-1 and 1183a-2 of the second buffer member 1183 may first be in contact with the rotation guide 1130.

In an example embodiment, the second protrusions 1183a-1 and 1183a-2 may have a shape that is inclined in one direction. The second protrusions 1183a-1 and 1183a-2 may have a shape that is inclined in a direction (X-axis direction) in which the second buffer member 1183 is spaced apart from the second axis (Y-axis).

In an example, the second protrusions 1183a-1 and 1183a-2 may be provided in a form in which a distance between the second protrusions 1183a-1 and 1183a-2 and the rotation guide 1130 increases as the second protrusions 1183a-1 and 1183a-2 approach the second axis (Y-axis), and conversely, the distance between the second protrusions 1183a-1 and 1183a-2 and the rotation guide 1130 decreases as the second protrusions 1183a-1 and 1183a-2 move away from the second axis (Y-axis). According to the structure as described above, since the gap between the second buffer member 1183 and the rotation guide 1130 may be formed narrowly in a portion in which a rotation amount of the rotation holder 1120 is relatively large, the collision may be effectively prevented.

The second buffer member 1183 may be spaced apart from the rotation guide 1130 when the rotation holder 1120 is in a neutral position, e.g., in a state in which one surface of the rotation holder 1120 and one surface of the rotation guide 1130 opposing the surface are parallel to each other, and when the rotation holder 1120 rotates about the second axis (Y-axis), a gap from the rotation guide 1130 may decrease, so that the second buffer member 1183 may first be in contact with the rotation guide 1130.

Additionally, although omitted in the drawings, the second buffer member 1183 may further include a second through-hole that penetrates through the second buffer member 1183.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A camera module, comprising:
a housing;
a reflection module disposed in the housing, the reflection module comprising:
a rotation holder disposed in the housing and provided with a reflective member; and
a rotation guide disposed between the housing and the rotation holder,
wherein the rotation holder comprises a plurality of buffer members that protrude toward the rotation guide, and
wherein the plurality of buffer members are provided on at least a surface of the rotation holder that faces the rotation guide to protrude toward the rotation guide.

2. The camera module according to claim 1, further comprising:
a plurality of ball bearings spaced apart from each other in a first direction between the rotation holder and the rotation guide, and configured to support a rotation of the rotation holder with respect to the rotation guide,
wherein the plurality of buffer members are spaced apart from each other in a second direction, perpendicular to the first direction in which the plurality of ball bearings are spaced apart, and the plurality of ball bearings are interposed between the plurality of buffer members.

3. The camera module according to claim 2,
wherein each of the plurality of buffer members further comprises a protrusion that protrudes toward the rotation guide, and the protrusion protrudes further from a surface of the plurality of buffer members that faces the rotation guide.

4. The camera module according to claim 3,
wherein the protrusion has a shape that is inclined in a direction in which the plurality of buffer members are separated.

5. The camera module according to claim 4,
wherein the protrusion is formed so that a distance between the protrusion and the rotation guide increases as the protrusion approaches the plurality of ball bearings and the distance between the protrusion and the rotation guide decreases as the protrusion extends away from the plurality of ball bearings.

6. A portable electronic device comprising the camera module of claim 1.

7. A camera module, comprising:
a housing; and
a reflection module disposed in the housing, the reflection module comprising:
a rotation holder disposed in the housing and provided with a reflective member; and
a rotation guide disposed between the housing and the rotation holder,
wherein the rotation holder comprises:
a first buffer member disposed on a surface that faces the housing; and
a second buffer member disposed on a surface that faces the rotation guide.

8. The camera module according to claim 7,
wherein a first ball bearing, comprising a plurality of ball members that are spaced apart from each other in a first axis direction, is disposed between the housing and the rotation guide,
wherein a second ball bearing comprising a plurality of ball members spaced apart from each other in a second axis direction, perpendicular to the first axis direction, is disposed between the rotation guide and the rotation holder, and
wherein the rotation holder and the rotation guide are rotated about the first axis with respect to the housing, and the rotation holder is rotated about the second axis with respect to the rotation guide and the housing.

9. The camera module according to claim 8,
wherein the first buffer member protrudes in the second axis direction, and the second buffer member protrudes in a third axis direction, perpendicular to both the first axis and the second axis.

10. The camera module according to claim 9,
wherein the first buffer member further comprises a first protrusion that protrudes toward the housing on a surface of the first buffer member that faces the housing, and the first buffer member has a shape that is inclined in predetermined direction.

11. The camera module according to claim 10,
wherein the first protrusion is formed so that a distance between the first protrusion and the housing increases as the first protrusion approaches the first ball bearing, and the distance from the first protrusion and the housing decreases as the first protrusion extends away from the first ball bearing.

12. The camera module according to claim 9,
wherein the second buffer member further comprises a second protrusion that protrudes toward the rotation guide on a surface of the second buffer member that faces the rotation guide, and the second buffer member has a shape that is inclined in a predetermined direction.

13. The camera module according to claim 12,
wherein the second buffer member comprises a plurality of second buffer members that are spaced apart from each other in the first axis direction with the second ball bearing interposed therebetween.

14. The camera module according to claim 13,
wherein the second protrusion is formed so that a distance between the second protrusion and the rotation guide increases as the second protrusion approaches the second ball bearing, and the distance between the second protrusion and the second ball bearing decreases as the second protrusion moves away from the second ball bearing.

15. The camera module according to claim 7,
wherein the first buffer member and the second buffer member are integrally formed with the rotation holder through a support frame.

16. A portable electronic device comprising the camera module of claim 7.

17. A camera module, comprising:
a reflection module according to claim 1;
a lens module comprising a plurality of lenses that refract light passing through the reflection module; and
an image sensor module comprising an image sensor configured to convert light passing through the lens module into an electrical signal.

18. The camera module according to claim 17,
wherein the rotation holder faces the housing in a first direction, different from a second direction in which the rotation holder faces the rotation guide, and the plurality of buffer members are further provided on a surface of the rotation holder that faces the housing to protrude toward the housing.
